(19) United States
(12) Patent Application Publication
(10) Pub. No.: US 2026/0131964 A1
(43) Pub. Date: May 14, 2026

(54) CAPSULE INTENDED FOR RECEIVING A SUBSTANCE FOR PREPARING A BEVERAGE, AND PRODUCTION METHOD

(71) Applicant: BRAIN CORP SA, Leudelange (LU)

(72) Inventor: Olivier BRIVOIS, Leudelange (LU)

(21) Appl. No.: 19/099,483

(22) PCT Filed: Jul. 31, 2023
(86) PCT No.: PCT/EP2023/071120

§ 371 Date: Jan. 29, 2025

(30) Foreign Application Priority Data
Aug. 1, 2022 (LU) LU502614

(51) Int. Cl. B65D 85/804; B65D 65/46; D21J 3/10

(52) U.S. Cl. CPC B65D 85/8043; B65D 65/466; D21J 3/10

(57) ABSTRACT

The invention relates to a capsule (1) for receiving a substance for preparing a beverage, said capsule comprising a body having a side wall (2) bordered on either side by a base (3) and by a rim (4) surrounding an opening (5) in said body, the body being formed by dry-moulding a sheet of cellulose pulp.

The invention concerns a capsule intended for receiving a substance for preparing a beverage, as well as a method for producing the body of such a capsule by dry-molding.

Capsules are known whose body has a side wall bordered on either side by a base and by a rim surrounding an opening in said body, the substance for preparing a beverage being introduced into said capsule through said opening, then enclosed inside said capsule by associating, for example by gluing, a lid on the rim to conceal the opening.

Such capsules are intended in particular for the preparation of a hot beverage such as coffee, tea or infusion. To do so, a capsule is installed in the housing of a machine provided for that purpose, where it is held by a piston while an extracting liquid, such as hot water, is passed through it and the substance it contains.

The capsule must be open to allow the beverage to flow through it, but the substance must be kept in the capsule with good barrier properties against oxygen and air moisture in order to preserve its organoleptic properties.

For this purpose, capsules are known whose body is formed by stamping a sheet of metallic material, particularly aluminum. Such capsules have good air and moisture-tight properties, but are expensive to produce and difficult to recycle.

Also known, for example from documents WO-2019/185637 and WO-2022/112615, are capsules whose body is formed by injection molding of a compostable plastic material, these capsules further comprising a sealing film which is associated with at least one of the base, side wall or upper opening of said body, in particular during its molding according to an IML (In-Mold Labelling) method, said film being compostable and having oxygen and/or moisture barrier properties.

These capsules have an improved ecological impact, in that they are in particular biodegradable and compostable, both industrially and domestically, and also guarantee good organoleptic preservation of the substance they contain.

In practice, however, these capsules are costly and complex to produce.

The invention aims to improve the prior art by offering a capsule combining good oxygen and moisture barrier properties with limited ecological impact, in particular by being biodegradable and/or compostable, while being easy and inexpensive to produce.

To this end, according to a first aspect, the invention proposes a capsule intended for receiving a substance for preparing a beverage, said capsule comprising a body having a side wall bordered on either side by a base and by a rim surrounding an opening in said body, the body being formed by dry-molding a web of cellulose pulp.

According to a second aspect, the invention proposes a method for producing the body of such a capsule by dry molding, which provides for:
forming a web of cellulose pulp;
thermoforming the capsule by hot-molding said web.

Further features and advantages of the invention will become apparent from the following description, made with reference to the appended figures, in which:

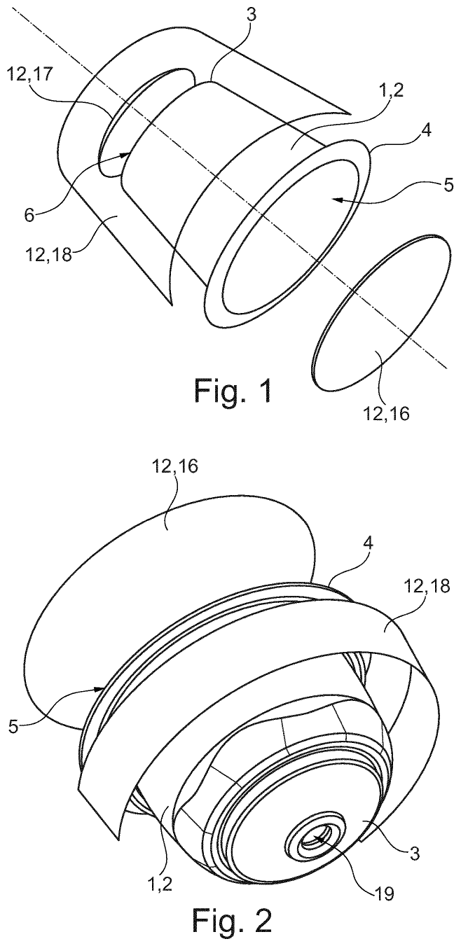

FIG. 1 shows an exploded perspective view of a capsule according to one embodiment of the invention;

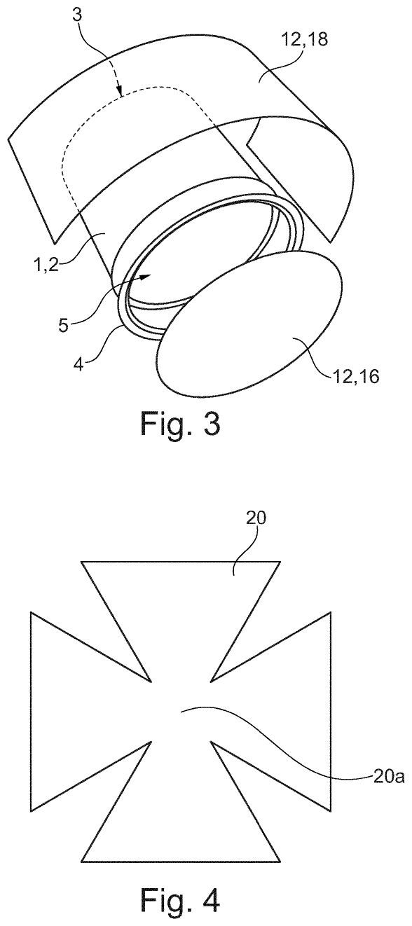

FIGS. 2 and 3 each show an exploded perspective view, from below (FIG. 2) and from above (FIG. 3) respectively, of a capsule according to respectively another embodiment of the invention;

FIG. 4 is a representation of a cross-shaped geometry formed around the area of the web of cellulose pulp to be molded.

In relation to these figures, a capsule 1 intended for receiving a substance for preparing a beverage is described below.

The capsule 1 comprises a body with a side wall 2 bordered on either side by a base 3 and by a rim 4 surrounding an opening 5 in said body.

The body is formed by molding a cellulose pulp, and preferably contains exclusively cellulose, in particular coming from 100% sustainable and/or organic farming.

In this way, an easily recyclable capsule 1 can be produced inexpensively and with high efficiency, with reduced carbon dioxide emissions, especially compared with plastic injection molding.

In addition, the exclusive use of cellulose makes it possible to obtain a capsule 1 whose body can be easily composted, both industrially and domestically, in particular with a reduced composting time (of the order of one month) compared with the average composting time for capsules made from compostable molded plastic (around 6 months).

In particular, the capsule 1 is biodegradable and/or compostable according to EN 13432 standard.

The body of the capsule 1 is formed by dry-molding a web 20 of cellulose pulp, which considerably increases the capsule's production yield while limiting the number, size and cost of the installations required, as well as water and energy costs.

In particular, the use of such a production method makes it possible to obtain a capsule 1 production yield of the order of 1000 capsules per minute, for an annual production volume greater than one billion capsules 1.

The method for producing the body of the capsule 1 by dry molding provides for:
forming a sheet 20 of cellulose pulp;
thermoforming the capsule 1 by hot-molding said sheet.

In one embodiment, the method for producing the body of the capsule 1 provides injecting air into the web 20 of cellulose pulp prior to thermoforming. In particular, the method may provide for:
separating cellulose fibers from a cellulose source, in particular by grinding a natural cellulose source, such as wood pulp, cotton, flax, hemp or sugar cane, or a recycled source, such as paper, cardboard or textiles;
collecting the cellulose fibers thus separated on a conveyor belt, in particular by injecting air into them upstream of their grinding, using a process known as “air laid”, so as to form a thick, dense, fluffy layer on said conveyor belt, with a grammage of between 300 and 15,000 g/m²;
compacting said fluffy layer, in particular by passing it between two compressor rollers, possibly heated, so as to obtain a web 20 of cellulose pulp of controlled thickness, in particular between 500 and 700 μm;
preheating said web, in particular to a temperature of between 150 and 170° C.;
compressing said preheated web in a suitably shaped mold, in particular by means of a hydraulic press, with a pressure of the order of 45 MPa, in order to thermoform capsule 1 bodies from said compressed web.

In another embodiment, the method for producing the body of the capsule 1 provides for forming the web 20 in the form of a sheet of cellulose pulp, in particular with a thickness of between 0.5 and 1 mm, for example of the order of 0.75 mm. In particular, the sheet may be based on cellulose pulp of the NBSK (Northern Bleached Softwood Kraft) type.

Advantageously, the sheet can be wetted, for example by spraying water onto the surface thereof, prior to thermoforming so as to improve its moldability while allowing the water to evaporate during thermoforming.

In one embodiment, the geometry of the web 20 can be modified, in particular by cutting, to improve thermoforming of the capsule 1. FIG. 4 shows a cross-shaped geometry formed around the central part 20a of the zone of the web 20 to be molded, this geometry being arranged to improve the stretching capacity of said web in the molding cavity in order to secure the formation of the capsule 1, particularly with respect to its thickness.

In one embodiment, the web 20, particularly when it is in the form of a sheet of cellulose pulp, can be preformed prior to thermoforming in order to facilitate shaping of the capsule 1 in the hot mold. In particular, especially for a cross-shaped geometry, the web 20 can be preformed in the shape of a cone, for example extending around the center 20a with the arms of the cross folded over.

The cellulose pulp used makes it possible to achieve the food compatibility required for packaging a substance for preparing a beverage in the capsule 1, in particular by dispensing with the need to add a food-compatible inner lining.

In particular, the cellulose pulp used is free from substances harmful to health and/or the environment, which could contaminate the substance for preparing a beverage through contact with the body of the capsule 1.

Advantageously, the cellulose pulp forming the body of the capsule 1 comprises micro-fibrillated cellulose (MFC), in particular between 1% and 50% by weight of MFC.

MFC microfibrillated cellulose is made up of individual cellulose microfibrils or aggregates thereof. These microfibrils generally have a diameter of 2 to 20 nanometers, and a length of the order of a few micrometers. Microfibril aggregates are composed of several cellulose microfibrils agglomerated together.

The production of MFC microfibrillated cellulose is based on the release of constituents from the secondary wall of lignocellulosic fibres by mechanical means coupled with enzymatic or chemical pretreatments. The fibres used can be unbleached or bleached chemical pulps, mechanical pulps produced from wood, recycled pulps, etc.

In relation to FIGS. 1 to 3, the body of the capsule 1 has a geometry of revolution around a central axis forming a side wall 2 which is generally inscribed in a truncated cone with a straight generatrix between the base 3 and the upper rim 4.

The capsule 1 is equipped with an upper lid 16 which is associated with the rim 4 to cover the opening 5, forming a substance-loading compartment in said body.

In the embodiments shown, the opening 5 can be used to load the substance into the compartment which is closed at the opposite end by the base 3, said opening then being closed by the upper lid 16 after said loading.

In FIG. 1, the base 3 comprises a lower opening 6 which is covered by a lower lid 17. In particular, the lower opening 6 can be covered first by the lid 17, in order to load the substance into the compartment through the upper opening 5, which is then closed by the lid 16.

Alternatively, the capsule 1 shown in FIG. 1 can be loaded through the base 3. In this case, the upper opening 5 is first concealed by the lid 16, then the capsule 1 is turned upside down so that the substance can be loaded through the lower opening 6, the lower lid 17 then being associated with said capsule to close said compartment before the beverage is prepared.

The capsule 1 is particularly intended for preparing a hot beverage such as coffee, tea or infusion. To do so, the capsule 1 can be placed in the housing of a machine provided for this purpose, so that at least one spindle can pass through it to inject an extracting liquid, in particular hot water, into the substance contained in the capsule 1.

The injection of liquid induces an increase in pressure in the compartment to allow, after rupture of a frangible wall of the capsule 1, the flow of the beverage out of said capsule.

During beverage preparation, the capsule 1 is injected with water at a temperature of between 86° C. and 90° C. and at a pressure of up to 20 bar, for a period of around 2 minutes. In particular, to prepare a coffee-type beverage, the quantity of water injected into the capsule 1 is between 40 mL and 150 mL.

The capsule 1 shown in FIGS. 1 and 3 is adapted to be arranged in a machine in which it is held by a piston provided with pins for piercing its base 3 or lower lid 17. In addition, the base 3 or the lower lid 17 is penetrated by at least one spindle to inject an extracting liquid into the substance contained in the capsule 1, which induces an increase in pressure in the compartment to allow, after rupture of the upper lid 16, the flow of the beverage through the opening 5.

According to the embodiment shown in FIG. 1, the lower lid 17 can be arranged to be easily penetrated by the injection spindles, in particular more easily than the cellulose base 3 of the capsule 1, in order to limit the risks of deformation of said capsule during use.

In FIG. 2, the base 3 has a central orifice 19 which opens into the substance storing compartment, as well as an upper wall which extends substantially radially into said compartment, and on which a network of raised pins is formed, a perforable membrane being arranged in said compartment between the substance and the raised pins.

Thus, when the capsule 1 is placed in a machine to prepare a beverage, the upper lid 16 is penetrated by at least one spindle to inject extracting liquid into the compartment, resulting in an increase in pressure, under the effect of which the membrane tears on the raised pins of the base 3, so as to allow the beverage to flow through the central orifice 19.

In order to preserve the organoleptic characteristics of the stored substance prior to its use in the preparation of a beverage, the capsule 1 must be watertight, in particular by forming a barrier against the circulation of oxygen and moisture, both towards the inside of said capsule, to avoid alteration of the substance it contains by ambient air and moisture, and towards the outside, in particular to avoid drying out of a substance packaged in moist and/or greasy form.

In particular, to ensure optimum preservation of the substance, the capsule 1 has the following features:
an oxygen transmission rate of less than 10 cm³/m²·day·atm, in particular not more than 5 cm³/m²·day·atm, and more particularly less than 1 cm³/m²·day·atm, measured in accordance with ASTM D3985 standard;
a water vapour transmission rate of less than 60 g/m²·24 h, and more particularly less than 10 g/m²·24 h, measured according to ASTM E96 standard under tropical conditions (38° C. and 90% humidity).

With such characteristics, the capsule 1 can be stored in particular:
before being filled with a substance for the preparation of a beverage: at a temperature of between 15 and 25° C., and up to 50° C. for a maximum of 6 weeks during transport;
after filling: in a dry and temperate place, with maximum ambient moisture of between 35 and 55%.

Advantageously, the body of the capsule 1 is subjected to a preliminary treatment to close the pores of the cellulose web 20 making it up, in order to form a first barrier against oxygen and water vapor.

In addition, the use of a cellulose pulp comprising MFC microfibrillated cellulose contributes favorably to the sealing of the capsule 1 against oxygen and water vapor.

However, should the material constituting the body of the capsule 1 not offer sufficient performance, in particular due to the porosity of cellulose, the side wall 2 can be covered with a sealing label 18 and/or a sealing coating forming a second barrier against oxygen and moisture.

The sealing coating and/or sealing label 18 can be applied to the side wall 2, not only to reinforce its oxygen and water vapor barrier properties, but also to provide it with additional barrier properties, in particular lipophobic properties, in order to further preserve the organoleptic properties of the substance stored in said capsule, but also to prevent impregnation of the body of the capsule 1 by the substance for preparing the beverage, when the latter is in the form of a moist and/or greasy paste.

In the embodiments shown, the lids 16, 17 allow to provide a tight seal for the capsule 1, notably by forming a barrier against oxygen and moisture.

In particular, the upper lid 16 and any lower lid 17 are attached to the body of the capsule 1 by heat-sealing, by applying a pressure of between 3 and 6 bar at a temperature of between 190° C. and 260° C. for approximately 350 ms.

In the embodiments shown, the side wall 2 is covered by a sealing label 18 which is formed from a sealing film 12, while the lower lid 17 can be made from the same film and the upper lid 16 from a film 12 as shown in document WO-2022/112613.

The sealing label 18 can be associated with the side wall 2 during or after the moulding of the body of the capsule 1, according to an IML (In-Molding Labelling) process, during which said label is placed against a side wall of a moulding cavity of said body before said moulding is actually carried out, so as to simultaneously carry out the steps of forming said body and associating said label with its side wall 2. Alternatively, the label can be associated by thermoforming.

The sealing label 18, and more generally the film 12 constituting said label and the lid(s) 16, 17, may also comprise cellulose, in particular comprising MFC microfibrillated cellulose.

In particular, the sealing film 12 comprises at least one layer based on MFC microfibrillated cellulose. Advantageously, the MFC layer can be in the form of a paper layer formed with microfibrillated cellulose so as to be highly fibrillated, and in particular translucent, so as to be particularly oxygen-barrier.

Furthermore, the use of a cellulose pulp comprising MFC microfibrillated cellulose contributes favorably to the association of the label 18 on the side wall 2, in particular by limiting the granulosity of said wall.

For aesthetic and/or commercial reasons, particularly in connection with the production of the label 18, the MFC layer can be provided with an ink-deposited print on one of its faces, said print comprising, for example, textual information and/or a decorative element, such as a logo, a brand name and/or a description of the substance contained in the capsule 1.

In particular, as the MFC layer is transparent, the printing ink can be deposited on its inner surface for protection. In addition, to improve the aesthetic qualities of the capsule 1, the printing may have gloss and/or antistatic properties.

According to some examples of embodiments, the MFC layer has:
a thickness of between 30 and 70 μm; and/or
a mass per unit area of between 40 and 90 g/m².

In particular, the MFC layer makes it possible to obtain a sealing film 12 with a high mass per unit area and sufficient oxygen impermeability for the barrier function, while at the same time being perfectly biodegradable and/or compostable.

The sealing label 18 may have been treated to improve its resistance to moisture, for example by means of the sealing coating, applied in the form of a lacquer or by metallization on said label. Alternatively, the sealing coating is applied directly to the side wall 2 of the capsule 1. Moreover, the sealing coating can also be applied to at least one of the lids 16, 17.

Advantageously, the sealing coating, like the sealing film 12, is biodegradable and/or compostable, in order to improve the overall environmental impact of the capsule 1, in particular by avoiding the need for the consumer to separate the label 18 and the lid(s) 16, 17 from the body of the capsule 1 prior to composting.

In one embodiment, the sealing coating may comprise MFC microfibrillated cellulose, for example derived from food plants, in particular root vegetables such as beet. Such a composition is in particular the subject of document EP-3 145 958.

The sealing coating can be based on an aqueous dispersion of MFC microfibrillated cellulose, in particular comprising between 0.5% and 20% by weight of MFC microfibrillated cellulose, especially less than 5% by weight.

According to one embodiment, the sealing coating is based on an anionic dispersion of MFC microfibrillated cellulose, and in particular has the following characteristics:
a solid particle content of around 32% by weight;
an approximately neutral or slightly basic pH, of the order of 7 to 8;
a viscosity of between 300 and 500 mPa·s;
a density of around 1.02 at 20° C.

Such an anionic dispersion has excellent oxygen and moisture barrier properties, as well as excellent grease and oil tightness, and can be heat set on its application substrate, notably the side wall 2 of the capsule 1 and/or the label 18 that covers it, so as to form thereon a sealing barrier as desired.

In particular, the sealing coating can be applied by dipping, spraying or transfer, before being possibly exposed to a heat source of suitable temperature to form the sealing coating. Advantageously, the mass per unit area of the sealing coating is between 2 and 12 g/m².

Furthermore, the sealing film 12, in particular the label 18, may comprise a sealing layer on the body of the capsule 1, in particular on its side wall 2, said sealing layer being suitable for hot and/or cold sealing.

In one embodiment, the sealing coating forms a metallization layer, for example based on aluminum. In particular, this layer can be applied by transfer or spraying, by presenting a thickness of less than 10 μm, especially less than 1 μm.

1. A capsule (1) for receiving a substance for preparing a beverage, said capsule comprising a body having a side wall (2) bordered on either side by a base (3) and by a rim (4) surrounding an opening (5) in said body, said capsule being characterized in that the body is formed by dry-moulding a web (20) of cellulose pulp.

2. Capsule (1) according to claim 1, characterized in that the cellulose pulp comprises MFC microfibrillated cellulose.

3. Capsule (1) according to claim 2, characterized in that the cellulose pulp comprises between 1% and 50% by weight of MFC microfibrillated cellulose.

4. Capsule (1) according to claim 1, characterized in that it has an oxygen transmission rate of less than 10 cm³/m²·day·atm, according to ASTM D3985 standard.

5. Capsule (1) according to claim 4, characterized in that the oxygen transmission rate is at most 5 cm³/m²·day·atm, and in particular less than 1 cm³/m²·day·atm, according to ASTM D3985 standard.

6. Capsule (1) according to claim 1. characterized in that it has a water vapor transmission rate that is less than 60 g/m²·24 h, measured according to ASTM E96 standard.

7. Capsule (1) according to claim 6, characterized in that the water vapor transmission rate is less than 10 g/m²·24 h, measured according to ASTM E96 standard.

8. Capsule (1) according to claim 1, characterized in that the side wall (2) is covered with a sealing label (18) and/or a sealing coating.

9. Capsule (1) according to claim 8, characterized in that the sealing label (18) and/or the sealing coating comprises MFC microfibrillated cellulose.

10. Capsule (1) according to claim 1, characterized in that it is biodegradable and/or compostable.

11. Method for producing the body of a capsule (1) according to any claim 1, by dry moulding, said method comprising:
forming a web (20) of cellulose pulp;
thermoforming the capsule (1) by hot-moulding said web.

12. Production method according to claim 11, characterized in that it provides, prior to thermoforming, for injecting air into the cellulose pulp web (20).

13. Production method according to claim 11, characterized in that it provides for forming the web (20) as a sheet of cellulose pulp.

14. Production method according to claim 13, characterized in that it provides for wetting the sheet prior to thermoforming.

15. Production method according to claim 11, characterized in that it provides for cutting the web (20) to form a cross-shaped geometry around the zone (20a) of said web to be moulded.
